(19) United States
(12) Patent Application Publication
(10) Pub. No.: US 2004/0029566 A1
(43) Pub. Date: Feb. 12, 2004

(54) Method and apparatus for controlling or monitoring access to the content of a telecommunicable data file

(76) Inventors: Jonathon Lucas Cunningham, Brighton, East Sussex (GB); Giles Sebastian Cunningham, Crawley, West Sussex (GB)

Correspondence Address: HARNESS, DICKEY & PIERCE, P.L.C., P.O. BOX 828, BLOOMFIELD HILLS, MI, 48303, US

(21) Appl. No.: 10/344,708

(22) PCT Filed: Aug. 15, 2001
(86) PCT No.: PCT/GB01/03651

(30) Foreign Application Priority Data
Aug. 15, 2000 (GB) 0019940.6

(51) Int. Cl. H04M 3/00

(52) U.S. Cl. 455/412.1; 455/418

(57) ABSTRACT

A method for controlling access to a telecommunicable data file provided by a content provider to one or more authorized recipients; comprising the steps of: encrypting the data file, associating with the encrypted data file a toll server software device; the toll server software device comprising; means for receiving authorization data from a potential recipient means for communicating the authorization data to a toll server for validation, and means for decoding the data file if authorization is validated, uploading the encrypted data file and toll server software device to a communications network accessible by recipients, downloading the encrypted data file and toll server device to a recipient requiring access to the data file, requesting authorization data from the recipient and communicating the authorization data to a toll server for validation, and, on successful validation, downloading a decryption key suitable for decrypting the data file from the toll server to the toll server device, and decrypting the data file. Optionally, the validation of authorization data may incorporate completion of a financial transaction, this may be effected through use of premium rate telephone lines using the novel method and system of the invention.

This invention relates to a method for controlling or monitoring access to the content of telecommunicable data files provided by content providers to authorised recipients. The data file may include any information, data and/or copyrighted material and may be provided via computer networks such as the Internet or intranet systems. The method and apparatus are particularly suited to applications where the content provider requires payment for releasing the file to a recipient and/or the data in the file is of a confidential or classified nature and is only intended for release to specifically authorised recipients. One aspect of the invention also has application in the sale of goods offered for sale on an e-commerce or other website.

There has been a rapid increase in on-line trading where customers place orders and pay for goods over the Internet. These are commonly known as e-commerce systems. Payment is generally effected by the customer providing credit or debit card details which are then checked with the issuer of the card and validated by the provider of the goods. When the payment is authorised, the goods are despatched to the customer. A charge is often made by the card issuer to the provider of the goods for use of the card. The cost of the required infrastructure and transaction costs associated with existing e-commerce systems set a lower limit to the minimum size of transaction which can be efficiently carried out via the Internet and also affect the profitability of trading using such systems.

There are currently three principal generic approaches to payment within e-commerce systems. The definitive elements of these existing technologies are described below:

1. The buyer and vendor can employ a trusted third party to certify the transaction. This third party will be furnished with all the necessary sensitive information, such as credit card and bank details, to certify the transaction as valid online. The actual transfer of funds can take place offline via conventional means. First Virtual is an example of this type of service.

2. The second system is an extension of conventional Notional Fund Transfer techniques such as those employed by cheque or credit card users. CyberCash™, and Visa/Mastercard's SET (Secure Electronic Transfer) based transactions are typical of this type. Here the buyer's account information relating to their credit card is relayed to the vendor over the Internet, usually in encrypted form. This information is sent to the buyer's bank or credit card company to make the necessary adjustments to the buyer's and vendor's accounts. This approach to e-commerce is currently the mainstay of e-commerce despite continuing concern over security and the effective lower limit to the value of transactions that are possible as mentioned above.

3. The third type of transaction currently has a plethora of variations encompassing digital cash, electronic money and coins, examples of which include e-coin, Mondex™, and Beenz™.

The difference between these and the other systems is not just that there is scope for the anonymity of the buyer but that they effectively allow the transfer of a form of currency over the Internet as opposed to the notional transfer or certification of transaction validity of the other two generic systems. Interception of this form of traffic could constitute theft of property not simply information.

While there are numerous systems adopting this third approach, they fall into four generic subtypes:

a) Smart Cards which store details of a buyer's account in a chip in the card. This interacts with vendor's equipment when connected by a suitable device over the Internet or even a direct telephone line. This system requires the acquisition of complex dedicated hardware by both the vendor and buyer. An example of this system is Mondex.

b) Anonymous electronic money such as E-coin™ and DigiCash™ which may allow the buyer to conduct transactions anonymously over the Internet in the same way as physical money in the form of coins and notes allows anonymous purchase from a vendor face to face. In essence this type of currency is a complex piece of unique code originated by the system operator with whom the buyer sets up an account. The buyer can then send this over the Internet and the code is modified by each transaction.

c) Identified electronic money is very similar in concept to the above except the code contains an identifier which links all transactions back through to the original buyer. This can be the case with type 3b) but only if there is an instance of Double Spend, whereby a buyer attempts to spend the same electronic money twice. This is a necessary fraud prevention measure.

d) Lastly there are loyalty schemes such as the system operated by Beenz. These differ from the preceding models in that credit is accrued by the Beenz account holder's behaviour, which may include accessing certain websites or buying certain products. The Beenz account holder does not need to buy a Beenz credit directly, nor is he required to demonstrate a Credit Worthy status as with traditional Bank or Credit card based transactions. In effect the Beenz account holder earns an income paid in Beenz.

None of the existing approaches has yet proved simple and popular enough to attract widespread use. Normally they would require complex business arrangements with an Internet service provider and financial institutions to be effected, this renders them prohibitively complex and costly for use by individuals or small companies wishing to provide restricted or controlled access to their web-sites and data files.

Information and data are often provided on computer networks in a form which requires a password or other identification code to be provided before access is authorised. Often the content provider incorporates some form of registration system where they require a customer to provide certain details identifying themselves, the registration culminating in the user being issued with a user name and/or password which can be input to obtain unrestricted access to the content providers information at a later date. Content providers often use this information to monitor their customers access to their files and/or to quantify any payments required for access to the content providers information.

The present invention aims to provide an inexpensive and simplified system for controlling access to telecommunicable data files.

In accordance with the present invention there is provided a method for controlling access to the content of a telecommunicable data file provided by a content provider to one or more authorised recipients; comprising the steps of:

encrypting the data file

associating with the encrypted data file a toll server software device;

the toll server software device comprising:

means for receiving authorisation data from a potential recipient

means for communicating the authorisation data to a toll server for validation

and means for decoding the data file if authorisation is validated,

uploading the encrypted data file and toll server software device to a communications network accessible by potential recipients

downloading the encrypted data file and toll server device to a recipient requiring access to the data file

requesting authorisation data from the recipient and communicating the authorisation data to a toll server for validation, and

on successful validation, downloading from the toll server to the toll server device a decryption key suitable for decrypting the data file.

Optionally the authorisation data is in the form of a financial transaction where the recipient provides details to enable a debit to be made from his funds to the content provider's account and confirms his agreement to this debit. In this embodiment, the recipient may have previously registered his details with the toll server provider and may have an account with the toll server provider. An individual's account may then be used to transfer payment or other authorisation data to any number of content providers who are also registered with the toll server provider. Thus the authorisation and financial transactions are carried out independently of the content provider and anonymous transactions may be effected.

Funds are transferred from the recipient to the toll server and then from the toll server to the content provider. Optionally, the financial transaction between the recipient and the toll server provider is effected through use of a premium rate telephone line associated with the toll server provider. Once authorisation data has been received, the recipient is connected with a premium rate telephone line for a pre-defined period sufficient to cover the charges payable to receive the required data file. The charge payable to the content provider is then transferred through an account or other financial arrangement between the toll server provider and the content provider.

In some embodiments, the authorisation data may be provided in the form of a password or personal identification number unique to the recipient and/or the content provider. In these embodiments the unique password or personal identification number is validated by the toll server. Optionally a debit may be made from the content provider's account to the toll server provider each time a user is authorised.

In other related embodiments, the recipient is replaced by an advertiser having a click-through advertisement on the content provider's website. The advertiser or advertisement has a unique password or personal identification number which is relayed to the toll server each time a user clicks through to the advertisement and is validated by the toll server as described for the previous embodiment. In this embodiment a transaction is made debiting finds from the advertiser's account to the toll server provider and then from the toll server to the content provider. The advertiser can then be charged a variable charge for rental for space on the content provider's site based on the number of validated click-throughs obtained through the content provider's site.

In a variation of this advertising embodiment, transfer of funds may instead be made to the recipient, as an inducement to view the advertisement. The same mechanisms may be used to verify that the recipient has seen the advertisement, such as by requiring the recipient to enter a password which is contained in the advertisement.

These embodiments may also be combined, so that the financial inducement to view an advertisement is made equal to the cost of viewing the content provider's content. In this case, the recipient may obtain access to telecommunicable data files by first viewing an advertisement, without the recipient undertaking any explicit financial transactions the advertiser paying the content provider's fees.

Therefore, in another aspect the invention provides a method for monitoring access to a click-through advertisement on a content provider's website comprising the steps of:

associating a unique identifier with the advertisement and linking click-throughs to the advertisement with a toll server, whereby each time a click-through is made to the advertisement, the unique identifier is uploaded to the toll server, the toll server having means for recognising the unique identifier and thereby counting the number of click-throughs to the website.

Preferably the unique identifier is in a form which authorises a financial transaction to be made to the content provider. Most preferably, the financial transaction is effected by transfer of funds from the advertiser to the toll server provider and from the toll server provider to the content provider.

In embodiments incorporating this aspect of the invention, the unique identifier associated with the advertisement preferably provides access to the advertiser's account number which may be treated much the same as authorisation data provided by a recipient in the previously described aspect of the invention. The account details and this unique identifier can be inserted at the time the advertisement is constructed. Additional safeguards may be incorporated to prevent the content provider fraudulently generating “faked” customer click-throughs without the customer having seen the advertisement, means for implementing such safe guards are known in the prior art.

In each of the embodiments of the invention, the method is made possible by the provision of certain components (apparatus) in a networked computer system. Therefore, in another aspect, the invention provides an apparatus for controlling access to the content of a telecommunicable data file provided by a content provider to one or more authorised recipients, comprising;

an encoder

a toll server software device associated with the encoder and communicating with a toll server, the toll server software device comprising;

means for receiving authorisation data from a potential recipient

means for communicating the authorisation data to the toll server for validation

and means for decoding the data file if authorisation is validated, and the toll server comprising;

means for generating and validating authorisation data specific to a recipient and/or content provider

a decryption key for decoding a data file encoded by the encoder, and means for downloading the decryption key to the toll server device when the authorisation data is validated.

Conveniently, the means for receiving authorisation data and the means for communicating the authorisation data to the toll server for validation are provided in the form of a sub-routine written into the toll server software device. As an example, the subroutine may perform the following method steps;

requests authorisation data from the recipient, say in the form of an information

screen with a data input box;

receives an input in response to the request, say by the recipient entering data into the data input box;

uploads the input received to the toll server and requests validation of the authorisation data;

on receipt of validation, downloads the decryption key from the toll server.

The method and apparatus of the present invention enable a low-cost, Internet service suitable for anonymous transactions and can be used to cost-efficiently transfer nanopayments (i.e payments in smaller denominations than the currency used) and micropayments (small amounts of currency say up to about £20 sterling or the equivalent value in other currencies). In accordance with maximum charges imposed for single calls to Premium Rate Telephone services by the UK regulatory body (ICSTIS), multiple credit transactions may be utilised to build up sufficient credit for larger debit transactions.

It also enables authorised users to have anonymous access to certain data files provided on a network. The network may be internal, say a company's Intranet system.

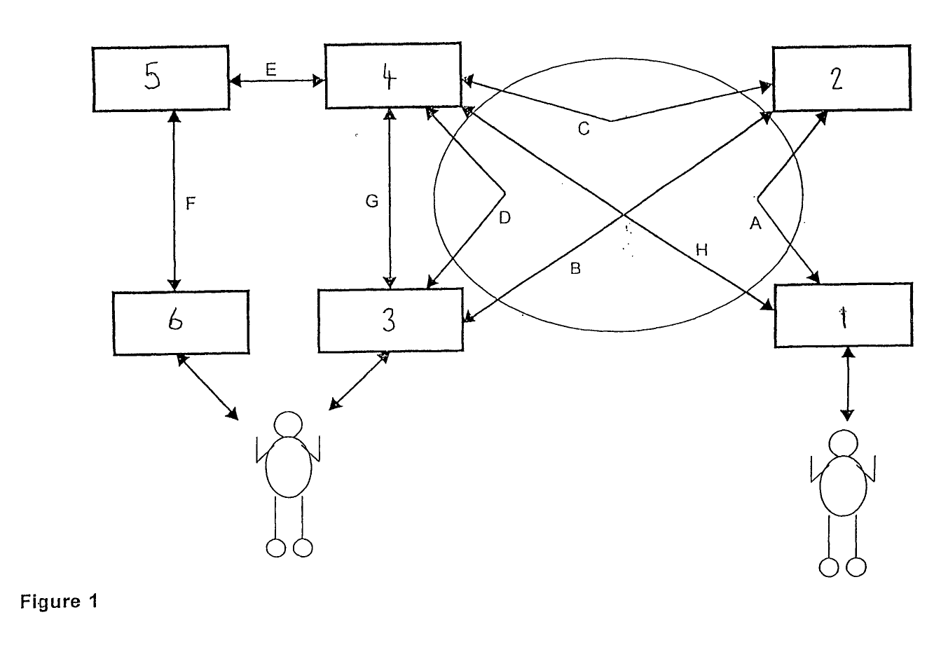

For the purposes of exemplification, some embodiments of the invention will now be further described with reference to the FIGS. 1, 2 and 3, in which:

FIG. 1 shows schematically the apparatus of the invention as it interacts with existing apparatus, the flow of information between various components of the overall system is also detailed; and

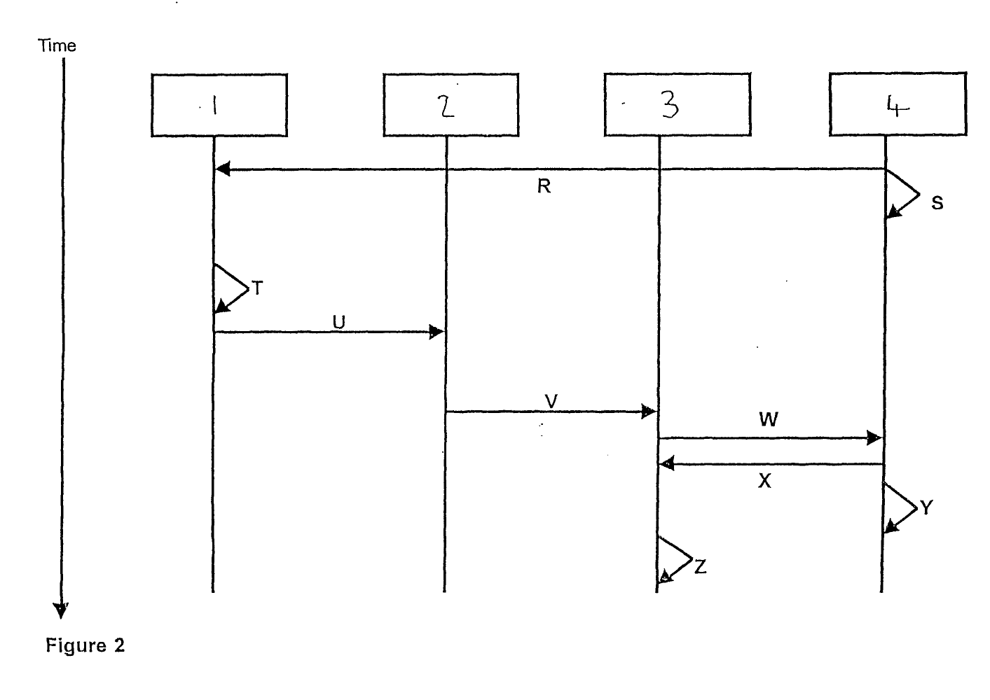

FIG. 2 shows the sequence of the method steps carried out by the embodiment of FIG. 1 in terms of data communicated from and to a toll server according to the invention;

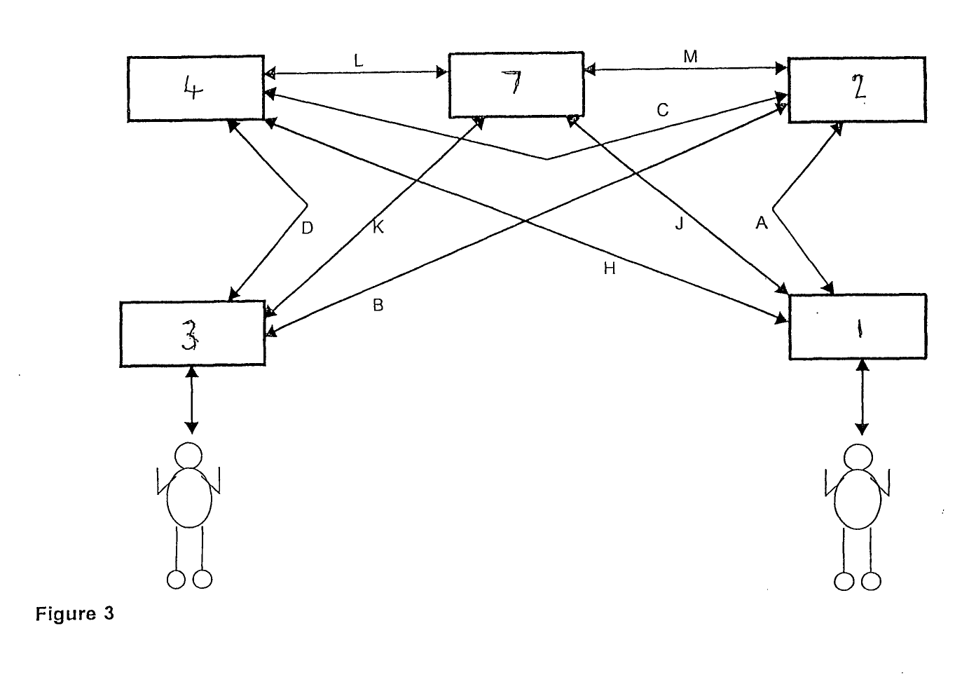

FIG. 3 shows some additional links extending FIG. 1 for the embodiments related to advertising. Different embodiments require different combinations of these additional links.

In the described embodiments, the content provider is the supplier of protected information or goods for sale via an e-commerce Internet website and the recipient is a customer seeking to access protected information or purchase goods offered for sale via that web-site as appropriate in the context.

FIG. 1 summaries the behaviour of the principal components of the apparatus of the embodiment, and the various electronic, or otherwise, communications that take place between these components and the other components of the system. The main components are referenced 1 to 7. (Component 7 is shown only in FIG. 3). The communication paths are referenced A to H. (A to M in FIG. 3). The skilled addressee will understand that not all components and communication paths need be used in every transaction effected by the apparatus.

Component 1 is the content provider's computer system. For simplicity this is represented as a single machine but may in practice constitute a more complex computer system.

Component 2 is an e-commerce site, i.e. in a typical e-commerce system it represents the machine or machines which are accessed by a customer who selects the web address of the e-commerce site. Although only one “component 2” is illustrated, just as only one customer is illustrated, it is to be understood that the apparatus and method of the invention may be used to effect payment collection and/or control access to any number of different websites by any number of customers.

Component 3 is any customer's computer, again the apparatus and method of the invention can be accessed and operated by a plurality of customers simultaneously.

Component 4 is the toll server of the invention, typically this may comprise one or more computers carrying out different functions, principally the “Internet tollbooth” function as explained below. Other functions are those commonly used in the art to support systems carrying out financial transactions, for example; database, accounting, sales and customer relationship functions. All these separate functions could, in principle, be carried out on physically remote computers which have been networked.

Component 5 represents a hardware system for answering one or more telephone lines, by computer controlled equipment. The component is capable of answering calls, playing pre-recorded or synthesised voice messages, and recognising “touch-tones” as emitted by touch-tone dialling telephones. The skilled person will appreciate that variants of this component 5 may have additional capabilities, such as voice-recognition software or hardware. All such functions are commercially available in the prior art, and will not be described in farther detail here.

Component 6 is any conventional telephone apparatus available to the customer for calling premium rate services.

Component 7 (FIG. 3) is a computer system representing an advertiser's computer(s). As an e-sales site, it functions exactly as for component 2, but serves additional functions in some embodiments of the advertising click-through mechanism.

All the links except E, F and G represent permanent or occasional Internet connections (when the network of the embodiment is the Internet), which may be made via one or more ISPs (Internet Service Providers). In some cases, link A may be an internal network connecting within a large organisation (when it owns both components 1 and 2, and has them physically located together). The exact form of link A does not affect the operation of the invention.

Link E represents an internal link, between components 4 and 5 which together constitute the Internet Payment and Tollserver system of the invention. In some variations of the embodiment, components 4 and 5 may form part of a single computer system, in which case link E would represent a purely software connection. For more complex embodiments, components 4 and 5 may by located physically remote from each other, in these embodiments, link E represents any permanent secure data connection such as a permanent secure Internet connection (as in a VPN—Virtual Private Network).

Link F represents a telephone link between components 5 and 6.

Link G represents a modem link between components 3 and 4. Where link D is implemented via a “dial-up” connection to an ISP via a modem, links D and G would not usually be concurrent. In the (unlikely) event that the component 3 had at least two modems connected to different telephone lines, or one modem connected to a telephone line and some alternative connection method to the Internet (e.g. via a LAN—Local Area Network—and through a Router or similar arrangement) then D and G could be concurrent. In such a case, link G would perform, under software control, much as for link F in the normal case. Thus, in what follows, the use and operation of Link G is described as if in the non-concurrent case, merely noting that Link G could be used as an alternative to Link F in the rare case that links D and G could be operated concurrently.

FIG. 2 illustrates the sequence of interactions between all the components of the embodiment of FIG. 1 involved in payment-to-content provider authorisation (i.e. excluding the payment-from-customer components) as detailed in the following description. These interactions involve components 1, 2, 3 and 4. These are represented in boxes across the top of FIG. 2. Vertical time-lines descending from each of these boxes represent the same components progressively through time. Interactions between components are shown by arrows between these vertical lines. The time sequence of these interactions is indicated by the position of the arrow relative to the time for a component. The progression of time is represented by the arrow to the left of the Figure. Bent arrows, which begin and end on the same time-line (S, T, Y and Z) represent processing which takes place at that relative time indicated, on the corresponding component computer system.

For parts of the detailed explanation of the system, it is necessary to distinguish the case where the information available from the e-commerce site (2) rather than goods advertised for sale via the site, is of value. Some examples of such include weather forecasting services, share price information services, news services, translation services, dictionaries, reference works, pictorial artworks, entertainment services such as novels, short stories, jokes, and cartoons.

Hereafter, the term “content” will be used to describe both information and saleable goods which may be available from the content provider and obtainable following completion of a financial transaction via the e-commerce or other website.

In preparation for performing the method of the invention, the content provider prepares a website detailing his content. This is done at the content provider's own computer system (1). Where the content is simply details of goods which can be purchased from the content provider, the web-site is then made available to potential recipients or customers by placing on an e-commerce site (2) typically in the form of a web server. This is achieved by conventional means uploading the information via link A to an Internet server. The content provider, may maintain his own e-commerce site, or may place his e-commerce site (2) via a third party Internet service provider (ISP). Whichever route is taken to placing the content on an e-commerce site does not materially affect the present invention. With the system described herein the e-sales site need not be secure in order to provide secure transactions.

A potential customer or recipient can access the e-commerce site (2) from his own computer workstation by conventional means using the Internet.

Where the content is primarily information which can be downloaded from the web-server by the customer on payment of a charge, the toll server of the invention is incorporated into the system. The toll server (4) is a novel machine and software forming part of the apparatus of the invention. It acts independently much as any other resource on the Internet. The toll server interacts with existing ISP's and the content provider's e-commerce site (2) without the need for any adaptation of those systems.

In order to use the toll server system, the content provider and the customer must each have an account, which may be temporary, with the toll server provider: the content provider at the time when they intend to publish their content, and the customer at the time they wish to access it. These (financial) accounts can be set up by conventional means or by the novel mechanisms described later as an optional aspect of the invention. The toll server system enables debits from the customer's account, and credits to the content provider's account. No involvement from any third party ISP or information server organisation is necessary.

On establishing an account with the toll server provider, the content provider is issued with the encoder and the toll server device. This is shown by events R and S on FIG. 2. These are provided in the form of software which may be downloaded via the Internet (Link H in FIG. 1, events R and S in FIG. 2). The software performs the following functions;

(a) encrypts the data file to which access is to be controlled

(b) associates a charge, specified by the content provider, which is payable before access to the unencrypted data file is permitted

(c) associates the toll server device which enables links between the web server, the customer and the toll server

The encrypted data file and associated device are then uploaded by the content provider to the e-commerce site and are accessible by a customer via a click-through link G.

The encryption key of the encoder (Key 1) is stored with the encrypted data-file but encrypted by a second key (Key 2). A third key (Key 3) retained by the toll server is used to decode Key 1. Table 1 summaries the three encryption keys used in this embodiment of the invention and their functions.

TABLE 1

| Key | Function | Held |
|---|---|---|
| 1 | encrypting/decrypting protected content | with encrypted data file |
| 2 | public | in the encoder software |
| 3 | private | on the toll server |

Examples of suitable public key systems are described in U.S. Pat. No. 4,200,770, U.S. Pat. No. 4,218,582 and U.S. Pat. No. 4,405,829.

The content of the controlled access data file is encrypted with Key 1. This Key 1 is itself encrypted with the public key of a public-key encryption algorithm, Key 2. Public key algorithms are typically quite slow, but only Key 1 needs to be encrypted/decrypted.

When the customer attempts to view the protected data, (represented as link B in FIG. 1, event V in FIG. 2) he is presented with a pro-forma page generated by the toll server device. This pro-forma requests the payment and includes buttons or another method allowing the customer to authorise the payment. Once the requested authorisation data is provided, a software algorithm embodied in the toll server device is activated.

The software algorithm can be realised in a number of ways, many of which are compatible with current technology, and some which extend it. For example, with current technology, the three popular “web-browsers” (Microsoft™ Internet Explorer, Netscape™ and Opera™) support functionally similar scripting languages such as JavaScript™ and JScript™m. The algorithm may be configured to be implemented by one of these languages. Alternatively, VBScript™, Java™, or plug-ins may be used to ensure compatibility.

The toll server device (embodying the algorithm) which includes the URL of the toll-server contacts the toll server (link D in FIG. 1, event W in FIG. 2) and identifies to the toll server three items: the public key, Key 2, embedded in the encrypted data file, the encrypted Key 1, and the charge payable by the customer to access the data file. This connection with the toll-server may be over a secure connection, such as is provided by the HTTPS protocol, to protect any sensitive financial data provided by the customer.

The toll server then validates the data provided by the customer and initiates a financial transaction to effect payment for the charge. This may be done by any conventional means, or by the novel methods in accordance with one aspect of the invention as described below. If the data is not validated, for example, if the customer does not have sufficient funds, refuses to make payment or is unauthorised in some other respect the toll server device will replace the original pro-forma page with another pro-forma page, detailing the refusal.

In the normal case, the transaction is approved. The validation or refusal process is represented as event X in FIG. 2. The toll server updates the customers account details and transfers appropriate funds to the content provider's account. This is represented as event Y in FIG. 2.

When the financial transaction is approved or completed, the toll-server activates Key 3 to decode Key 1, which is sent back to the device at the web server. This communication may again be over a secure connection, so that only the customer, who has paid for access, is able to receive the decoded Key 1. At this point, the customer may be disconnected from the Internet. No further communication charges need be incurred. On receiving the unencrypted Key 1, the toll server device decrypts the data file. This is represented as event Z in FIG. 2. This process can be quick or slow, depending on the level of encryption used. In any case, after the decryption takes place the customer can view the content of the data-file.

Thus it can be seen that the toll server device acts as a kind of opaque envelope. When the customer chooses to access the encrypted data file it is downloaded to the customer's web-browser, (as represented by event V in FIG. 2) but the encrypted content is not displayed. Instead, the toll server device presents the customer with a pro-forma page detailing the requirement to pay to see the content of the data file. The charge payable, inserted by the content provider into the pro-forma at the encoding stage (event T in FIG. 2) is included in the pro-forma displayed to the customer.

Once the encrypted data file has been downloaded to the customer's web-browser, it is virtually impossible to access the encrypted content without the key to the encoder. With a “weak” encryption algorithm, it may be infeasible for ordinary customers to break the encryption, but possible for Government bodies with specialised code breaking tools such as the police. For convenient deployment, and to allow easy access to data, the encryption algorithm chosen would preferably be fast as well as secure. The specific algorithm used is not important and many suitable algorithms may be found in the prior art.

In an alternative embodiment, instead of keys 2 and 3 being a public/private key-pair as described above, Key 2 may be replaced with the content provider's toll server account number, which is stored in the toll server. Key 3 becomes an ordinary encryption key, for an ordinary encryption/decryption process and is issued to the content provider as part of the toll server device instead of key 2.

There need not be multiple copies of the whole of the toll server software device; parts may be shared by multiple toll server “toll-booths”. Specifically, it is not necessary to insert the actual program code of the toll server device, it is sufficient to insert a URL so that when the device is needed it can be fetched from the toll server. Thus the encoder, the charge payable, the URL of the toll server and any data for enabling communication between the web-server and the toll server may be downloaded from an e-commerce or other website, yet the toll server device may be downloaded instead from the toll server. This approach may be preferred for security reasons; there are restrictions on which URLs an automatically downloaded piece of software is allowed to access. By automatically downloading the toll server device when needed from the toll server, the more onerous of these security checks become unnecessary, since the device is allowed to communicate back to the URL from which it was downloaded.

The toll server device need normally be automatically downloaded to any customer only once. The device can be stored in a “cache” in an authorised customer's computer for later use.

The device may be configured to provide access to the tollserver system only if authorisation is given by the customer. In an alternative arrangement, the device may be configured to gain access to the toll server system by either incorporating the device (once it has been downloaded) as a “plug-in” to a standard browser or to operate as a seperate piece of software. In another alternative, the customer can be asked to access the URL by providing a computer command to this effect.

In an alternative embodiment where it is desired to control access to a data-file to certain specified recipients rather than simply any paying customers, the toll server device is configured to provide a pro-forma page which requests the customer to supply a password or personal identification number instead of or as well as asking for payment. The password can be stored encrypted in the encrypted data file just as Key 1 in the previous embodiment. Table 2 details the keys used in this embodiment, their function and where they are stored:

TABLE 2

| Key | Used for | Held |
|---|---|---|
| 1 | encrypting/decrypting data file | with encrypted data file |
| 2 | public | in the encoding software |
| 3 | private | on the tollserver |
| 4 | password | with encrypted data file |

The preparatory steps are much as described for the previous embodiment, but as well as, or instead of setting a price to view a page, the content provider specifies a password. The content provider can distribute the password to authorised customers. On attempting to view a web page, the customer is presented with an initial pro forma as before, but the pro forma requests a password before contacting the toll server.

When the device contacts the toll server, it uploads to the toll server both the password provided by the customer and Key 4 (the content provider's password encrypted by Key 2).

The toll server uses Key 3 to decrypt Key 4 and compares the decrypted password with that provided by the customer. If they match, the toll server authorises the transaction as before and decodes Key 1 and downloads it to the customer. For authorised customers, the content provider's password, once it has been supplied by the customer as described, may be stored as a cookie on the customer's hard disk.

On future occasions, the toll server device may obtain the password from this “cookie” and initiate automatic decoding of the data file when it is downloaded.

It will be understood that Tables 1 and 2 above describe novel delivery systems for the decryption key: the decryption key is stored along with the encrypted data. Access to the data is controlled by controlling access to the decryption key, i.e, the invention essentially utilises a two stage process.

An important advantage of this aspect of the invention is that the content provider can generate as much content as they desire, each individual page being protected by a unique encryption key but that the toll-server does not need to store all these encryption keys. Specifically, the content provider can perform event T of FIG. 2 as often as they like, on their own machine (Component 1 of FIG. 1). This does not affect or impose any overhead on any other part of the overall system.

In a small scale operation, the toll-server needs only to store one public/private key pair. Any content provider may provide a million or more pages of information, each page separately protected, but the toll-server need store only one key. This is because the toll server device sends the encrypted encoder key (Key 1) along the with public key, Key 2 used to encrypt it.

In general, there will be many public/private key pairs, for added security. Typically each public key, Key 2 is unique to one content provider. If public keys are shared between content providers, then additional identification data will be required to distinguish different content-provider accounts in a fashion which will be readily apparent to the skilled practitioner.

In embodiments involving advertising payments, (FIG. 3) there are several variants:

In one, the Vendor, before encoding his content (event T) first downloads an advertisement link and “payment policy” software module from the advertiser (using link J). This module is incorporated as part of the toll serve software device during event T. Everything then proceeds as in the earlier description, except that when the customer attempts to “click-through” the advertisement, as for accessing encrypted content, the toll server software device runs the “payment policy” module (on the customer's computer, component 3) to determine whether to pay for the advertisement instead of the customer making this decision. If the module approves the payment decision, then the advertiser's account is debited instead of the customer's account, and the customer is allowed to access the URL data, which permits a connection (link K) to the advertiser's website. From this point on, the advertiser's website may act as another e-sales site, ie it now takes on the role of component 2.

In this embodiment, no changes or new software need be added to either of the e-sales sites, (components 2 and 7). As a special case, it may be noted that the minimal “payment policy” module is one which always says “yes” and approves the advertising payment. In this case, payments are made for every “click-through”. More complex policies may instead be implemented.

In the case where it is acceptable to add additional software to components 2 and 7, instead of a payment policy module it may be more efficient for the e-sales site (component 2) to notify the advertiser's site (component 7) via link M that a potential customer is interested in the advertisement. Any additional data about the customer which has been gathered by the e-sales site may be passed. Transfer of this customer may be offered for sale, at which point component 7 acts exactly as a customer computer (component 3) in its interaction with component 2, and may authorise the transaction using link L (by analogy with link D for the actual component 3). In principle, it would even be possible for the authorisation decision to be taken by a human operator interacting with component 7, although normally automated payment policy software would be used.

The following describes a novel method for effecting financial transactions via the e-commerce site (2) in the embodiments where payment is required before access to a particular data file is given. It is to be understood that whilst this novel aspect can be conveniently combined with the novel toll server system, the two may find applications independently of each other by combination with customer authorisation or financial transaction systems known in the prior art. In particular, it should be appreciated that the following novel payment method and apparatus may be used to effect payment for goods ordered through an e-commerce web-site of the type known in the prior art.

Component 5 of FIG. 1 represents an automated telephone answering service which is integrated with premium rate telephone lines.

In operation, the customer communicates with the toll server via two routes; the normal web browser route and a premium rate telephone line. When connected to the premium rate telephone line, the customer runs up a charge on that line which can later be settled by account. The customer may pay off charges as and when they become payable or may accrue credit by periodically connecting to the premium rate line. Charges can then be deducted from the accrued credit. These lines of communication are represented as Links D and F in FIG. 1. It is not necessary for the customer to be connected by both routes, connection to the premium rate line can be effected at a time when the customer is not connected to the web-browser. The customer may be provided with an option to connect with the premium rate telephone line either while he is connected to the web browser or when he is not.

The role of component 5 in effecting payment for access to pay-per-view information or goods offered for sale by the content provider is described as follows:

The customer may initiate payment either by using a voice telephone to call the premium rate line, or by connecting to the premium rate line via his modem.

If dialling the premium rate line from a voice telephone (represented as Link F in FIG. 1) the system may be configured to provide a spoken voice message requesting an authorisation code. The customer can choose to remain anonymous, or can identify himself to the system by entering an account number using the telephone keypad. Similarly, if he has used his modem, a dialogue box may be presented for entering an authorisation code.

The system may be configured to recognise a regular customer's telephone number using caller ID software. The customer's dedicated telephone number can be used in place of a separate account authorisation code.

Whether or not he has made his identity known to the automated answering system, the customer may be invited to indicate an amount he wishes to pay by entering a figure via the touch tone key pad of his telephone or his computer keyboard. Where the ID of the customer has not been made known to the automated system, the customer's telephone line can remain connected to the premium rate line sufficiently long to accrue a credit to the stated amount payable. Where the customer's identity has been made known to the system, payment can be effected by this or other means, some of which are detailed below. Optionally, a customer may simply connect with the premium rate line hold for a period of time and accrue credit to his account.

In another option, the system may be configured to permit the customer to use touch-tone dialling or his computer keyboard to enter a Purchase ID Key (PIK) code which may be supplied by the content provider in the e-commerce site (2). This system enables customers to purchase goods of lower values in one-off transactions (e.g. goods of value below the £20 limit imposed for single calls to premium rate phone lines as imposed by the UK regulatory (ICSTIS) body or equivalent restrictions in other countries). In particular customers have the ability to execute their transactions anonymously; without disclosing their private address and bank or credit card details, which also makes the process quick in comparison to systems requiring this type of credit clearance information. The PIK code has associated with it a value equivalent to the charge payable for certain goods. This enables the customer to buy a product advertised on the Internet by simply e-mailing a delivery address to the e-commerce site and then providing the automated system (5) with the appropriate PIK code.

If the customer has any unpaid purchases outstanding, and the customer has identified himself to the system (e.g. by account number or by using a telephone with caller-ID enabled and which has been previously identified so that its number is stored in the system), then he has the option to remain connected until the required amount has been debited to his telephone account. No other authorisation is needed, and the customer need not even remain by the telephone: the automated system will hang-up automatically after the right length of time.

In another option, where the payment is associated with content to which access is controlled by a toll server system as previously described, the customer may connect directly to the toll server using their modem (this is represented as Link G in FIG. 1). This may be enabled by a simple piece of software which could be downloaded from a website maintained by the toll server provider or provided on CD-ROM or any other suitable carrier. In relation to FIG. 1, this software element may comprise part of the toll server device (4). Access to the toll server device (4) for this purpose would be via the e-commerce site (2) using Link D of FIG. 1.

This payment enabling software would permit the customer to connect to the toll server via link G with a simple mouse click. This mode of use dispenses with the need to record and transfer code information on the part of the customer as this activity is done automatically by his computer (3) on his behalf.

If the customer has been identified, then the content provider's middleware can directly contact the toll server. If or when the customer pays, then the despatch of the goods or release of the protected data is authorised by a transaction ID code. This is a secure key using a suitable secure encryption algorithm. The transaction ID and the PIK code are conceptually distinct, the one is used between the toll server and the content provider, the other between the toll server and the customer. In practice, the actual codes used may be the same but the conceptual distinction remains.

The e-commerce site may be configured to request some information from the customer, such as his account number or other authorisation code used to identify the customer. This is transmitted to the toll server as previously described. A PIK code may be issued to a customer via the e-commerce site. This PIK code is visible to the customer on their computer monitor from the moment he selects an item for which payment must be made. The software of the PIK code may usefully include elements which provide an e-commerce site or content provider identifier, a product or protected data file identifier as well as the date and time of selection such that each PIK is unique.

With optional additional software on the customer's computer (3), the e-commerce site (2) can instruct the customer's computer (3) to use a modem to connect with the premium rate telephone line and make the payment automatically. The payment can be made either when the modem next becomes free, or can be set to make the payment at a convenient time (e.g. overnight) when the line is not otherwise in use. This additional software may also be provided via a website maintained by the tollserver provider from which it may be downloaded and automatically installed, or distributed via CD- ROM or other suitable carrier.

The e-commerce site should not despatch goods without having received a transaction ID code authorising payment.

There are several levels of sophistication possible for the charging system as defined by the interacting components 3, 4, 5 and 6 of FIG. 1. The simplest does not require any changes to a conventional e-commerce system (2), other than the addition of a single link to the toll server on the content provider's sales confirmation web-page (e.g. a single button labelled “Buy Now” or “Proceed” etc). This link uses a URL which encodes the transaction data including amount, etc. Since payment amounts are small, and the content provider is requesting money (to pay for the purchase) rather than distributing money, no great security issues are involved, and the connection can even be made over a normal HTTP link, although a secure connection (using SSL, a secure sockets layer connection) over SHTTP is preferred.

Authorisation, once payment has been received, can be sent by normal e-mail mechanisms. The e-mails can be processed automatically (e.g. by Microsoft Exchange Server) or verified manually. The authorisation takes the form of a transaction ID code which encodes the amount of the transaction and the e-commerce site details, using a public key encryption system as described below. This guarantees (i) that the toll server has approved the transaction, (ii) the amount which has been approved, (iii) third parties cannot fake authorisations.

Once a customer has communicated with the payment system of this embodiment, either by visiting the toll server provider's website directly or through an associated e-commerce site, the customer has the option to download automatic dialling software to simplify the payment process in future transactions. In one mode of operation, this software may enable the customer to simply click their mouse button, which in turn will automatically disconnect their computer from the Internet (links B or D) using their normal connection (usually via an ISP) and reconnect them directly with the toll server via a premium rate telephone line in order to make payment (link G). In this mode of operation, the additional software can operate so as to merely carry out the functions of Link F automatically—rather than requiring specific action by the customer. This mode of operation also permits the toll server (4) to act as an ISP, so that continuous charging is possible. For example, if the e-commerce site (2) is some form of on-line game where metered access is required, the link B is replaced by the links G and C (i.e. the toll server acts as an Internet Service Provider). Although this appears more complicated than the “direct” link B, it must be remembered that the link B represents an unspecified number of “hops” between computers carrying Internet traffic. If the customer's normal ISP has a poor route to the e-commerce site, whilst the toll server has a short route, the route via G then C could actually be shorter. In any case, there is no difference in principle, other than the rate of charging for the connection.

Following the completion of this transaction (or metered access) the customer will be given the option of having their computer automatically re-dialling their usual Internet connection to take them back to the website link they were disconnected from on the afore mentioned mouse click, or to remain disconnected. Once downloaded to the customer's computer (3) the automatic dialling software may be re-used again and again for transactions involving any websites provided by content providers who are registered with the toll server provider.

When this automatic dialling software is not required for immediate or metered access, it may be augmented with additional functionality to allow it to be configured to automatically connect to the toll server at customer predetermined times (for example when the customer is normally asleep and so not requiring the use of their computer/modem) or to determine when the modem is available. This can be achieved either by incorporating a timer interrupter alarm clock activation in the software, or by an additional piece of software downloaded to the customer's computer (3). Techniques for doing this are standard in the software industry, and provision for such functions are standard on many operating systems, including Microsoft™ Windows™, Unix™, Linux™ and MacOS™.

This additional functionality provided by this automatic dialling software has two purposes: firstly, once it is downloaded and set it causes no disruption to the customer's activities whilst completing the payment aspect of transactions. Secondly, in some cases, depending on the charging structure of the premium rate lines as paid by the toll server provider to the telecommunication company supplying the premium rate lines, this may permit lower operating overheads.

It is important to note that the provision of component 5 does not exclude the toll server system accepting payments by other methods, such as credit card payments or any of the more recent e-payment methods such as e-cash, millicent™, Mondex™ etc. Indeed, there is no technical difficulty in permitted manual crediting of customer accounts via conventional “back office” software incorporated in the toll server (4).

1. A method for controlling access to the content of a telecommunicable data file provided by a content provider to one or more authorised recipients; comprising the steps of:
encrypting the data file
associating with the encrypted data file a toll server software device;
the toll server software device comprising:
means for receiving authorisation data from a potential recipient
means for communicating the authorisation data to a toll server for validation
and means for decoding the data file if authorisation is validated,
uploading the encrypted data file and toll server software device to a communications network accessible by recipients
downloading the encrypted data file and toll server device to a recipient requiring access to the data file
requesting authorisation data from the recipient and communicating the authorisation data to a toll server for validation, and
on successful validation, downloading from the toll server to the toll server software device a decryption key necessary for decrypting the data file.

2. A method as claimed in claim 1 wherein the authorisation data is in respect of a financial transaction.

3. A method as claimed in claim 2 further comprising the steps of; electronically transferring funds from the recipient to the toll server and from the toll server to the content provider.

4. A method as claimed in claim 2 or claim 3 wherein the financial transaction is effected through use of a premium rate telephone line associated with the toll server provider.

5. A method as claimed in any preceding claim wherein the authorisation data is provided in the form of a password or personal identification number unique to the recipient and/or the content provider.

6. A method as claimed in any preceding claim wherein the communications network is the Internet.

7. A method for monitoring access to a click-through advertisement on a content provider's website comprising the steps of;
associating a unique identifier with the advertisement and linking click-throughs to the advertisement with a toll server, whereby each time a click is made on the advertisement, the unique identifier is able to contact the toll server, the toll server having means for recognising the advertisement by its unique identifier and thereby counting the number of click-throughs to the website.

8. A method as claimed in claim 7 wherein the unique identifier authorises a financial transaction to be made between the advertiser and the content provider and/or the party viewing the advertisement.

9. A method as claimed in claim 8 wherein the financial transaction is effected by transfer of credit from the advertiser to the toll server provider and from the toll server provider to the content provider, and/or the party viewing the advertisement.

10. A method as claimed in claim 8 or claim 9 wherein the financial transaction is effected by means of a premium rate telephone line associated with the toll server provider.

11. A method for performing a financial transaction between a vendor and purchaser through an e-commerce Internet website, comprising;
requesting authorisation data from the vendor
validating the authorisation data, telecommunicably connecting the purchaser with a premium rate telephone line for a period sufficiently long to accrue a charge equal to or greater than that payable in the transaction,
transferring appropriate funds to the account of the vendor and notifying the vendor that payment has been effected.

12. Apparatus for controlling access to a telecommunicable data file provided by a content provider to one or more authorised recipients, comprising;
an encoder
a toll server software device associated with the encoder and configured to communicate with a toll server, the toll server software device comprising;
means for receiving authorisation data from a potential recipient
means for communicating the authorisation data to the toll server for validation
and means for decoding the data file if authorisation is validated, and the toll server comprising;
means for generating and validating authorisation data specific to a recipient and/or content provider
a decryption key for decoding a data file encoded by the encoder, and means for downloading the decryption key to the toll server software device when authorisation data is validated.

13. Apparatus as claimed in claim 12 wherein the authorisation data is in the form of a password or personal identification number unique to the recipient and/or the content provider.

14. Apparatus as claimed in claim 12 or claim 13 wherein the means for receiving authorisation data and the means for communicating the authorisation data to the toll server for validation are provided in the form of an algorithm implemented by the toll server software device.

15. Apparatus as claimed in claim 14 wherein the algorithm performs the following steps;
requests authorisation data from the recipient
receives an input in response to the request
uploads the input received to the toll server and requests validation, and on receipt of validation, downloads the decryption key from the toll server.

16. Apparatus as claimed in any of claims 12 to 15 wherein the authorisation data is in the form of a financial transaction, the apparatus further comprising;
a telecommunications network connected with one or more premium rat telephone lines,
an automated answering system for answering calls made to the network, the answering system being configured to identify callers and/or receive information or instructions via a touch tone key pad relating to the amount of the financial transaction and to effect connection to the premium rate telephone line for a period sufficiently long to accrue a credit equal to or greater than the amount of the financial transaction.

17. Apparatus as claimed in claim 16 wherein the automated answering system incorporates caller ID recognition hardware and/or software.

18. A method for controlling access to a telecommunicable data file provided by a content provider to one or more authorised recipients substantially as described herein and with reference to the Figures.

19. Apparatus for controlling access to a telecommunicable data file provided by a content provider to one or more authorised recipients substantially as described herein and with reference to the Figures.

20. A method for monitoring access to a click-through advertisement on a content provider's website substantially as described herein and with reference to the Figures.
